(19) United States
(12) Patent Application Publication
(10) Pub. No.: US 2008/0009148 A1
(43) Pub. Date: Jan. 10, 2008

(54) Guided pin and plunger

(76) Inventor: Glenn Goodman, Cumberland, RI (US)

Correspondence Address: OCCHIUTI ROHLICEK & TSAO, LLP, 10 FAWCETT STREET, CAMBRIDGE, MA, 02138, US

(21) Appl. No.: 11/482,398

(22) Filed: Jul. 7, 2006

(51) Int. Cl. H01R 12/00

(52) U.S. Cl. 439/66

(57) ABSTRACT

An intercoupling component used to couple an array of electrical connection regions disposed on a first substrate to an array of electrical connection regions disposed on a second substrate. The intercoupling component includes an insulative support member including an array of holes extending therethrough, the array of holes located in a pattern corresponding to the array of electrical connection regions on the first substrate; and a plurality of terminals. Each terminal includes a socket including a socket head and a socket body, the socket defining a socket cavity; a pin including a pin head and a pin body, the pin head positioned within one of the array of holes, the pin body extending from the pin head and received at least partially within the socket cavity; and a resilient member configured to bias the socket head is biased away from the pin head.

### TECHNICAL FIELD

This invention relates to making connections between integrated circuit (IC) packages and circuit boards.

### BACKGROUND

Ball grid array (BGA) and land grid array (LGA) packages are becoming increasingly popular because of their low profiles and high densities. With a BGA package, for example, the rounded solder balls of the BGA are generally soldered directly to corresponding surface mount pads of printed circuit board rather tan to plated thru-holes which receive pins from, for example, a pin grid array (PGA) package.

Sockets are used to allow particular IC packages to be interchanged without permanent connection to a circuit board. More recently, sockets for use with BGA and LGA packages have been developed to allow these packages to be non-permanently connected (e.g., for testing) to a circuit board.

### SUMMARY

This invention features intercoupling components and terminals that can enable high-density interconnections between electrical components such as, for example, printed circuit boards and integrated circuit packages. As used herein, the term “integrated circuit package” is intended to mean integrated circuit packages including, for example, PGA, BGA, and LGA packages. Intercoupling components can include: an insulative support member and a plurality of terminals. Terminals can include a socket, a pin, and a resilient member.

In an aspect of the invention, intercoupling components, used to couple an array of electrical connection regions disposed on a first substrate to an array of electrical connection regions disposed on a second substrate, include: an insulative support member including an array of holes extending therethrough, the array of holes located in a pattern corresponding to the array of electrical connection regions on the first substrate; and a plurality of terminals, each terminal including: a socket including a socket body extending from a socket head, the socket defining a socket cavity within the socket body; a pin including a pin body extending from a pin head, the pin head positioned within one of the array of holes and contacting the insulative member, the pin body at least partially received within the socket cavity; and a resilient member configured to bias the socket head away from the pin head.

In another aspect of the invention, terminals, for use with an integrated circuit package having an array of electrical connection regions disposed on a first substrate, include: a socket including a socket body extending from a socket head, a socket cavity formed within the socket, and a socket retaining element disposed on an opposite end of the socket body from the socket head; a pin including a pin body extending from a pin head, the pin body at least partially received within the socket cavity; and a resilient member configured to bias the socket away from the pin head.

In another aspect of the invention, methods of assembling an intercoupling component include: providing an insulative support member including an array of holes extending therethrough, the array of holes located in a pattern corresponding to the array of electrical connection regions on the first substrate; inserting a socket into each of the array of holes; inserting a pin having a pin body extending from a pin head into each of the array of holes such that the pin head contacts the insulative support member; and inserting a resilient member into each of the array of holes; such that, after the socket, the pin, and the resilient member are inserted, the resilient member is interposed between the pin head and the socket and the pin body is received within a socket cavity defined within the socket.

Embodiments can include one or more of the following features.

In some embodiments, the resilient member includes a coiled spring.

In some embodiments, the resilient member includes electrically conductive material and forms part of a first electrically conductive path between the array of electrical connection regions disposed on the first substrate to the array of electrical connection regions disposed on the second substrate. In some cases, contact between the pin and the socket forms part of a second electrically conductive path between the array of electrical connection regions disposed on the first substrate to the array of electrical connection regions disposed on the second substrate. The pin body can include a protrusion extending radially outward from a cylindrical portion of the pin body and/or the socket body can include a protrusion extending into the socket cavity.

In some embodiments, each hole includes a first section having a first diameter and a second section having a second diameter that is smaller than the first diameter. In some cases, the pin head is press-fit within the first section of a corresponding hole. In some cases, the pin head is press-fit within the second section of the corresponding hole.

In some embodiments, the pin head includes a proximal contacting surface. In some cases, the proximal contacting surface includes a ball-shaped end.

In some embodiments, the socket head includes a concave ball-contacting surface. In some embodiments, the socket head includes a sharp protrusion extending from a contacting surface.

In some embodiments, a lateral distance between centers of adjacent holes is less than about 0.8 millimeter.

In some embodiments, the resilient member includes a coiled spring. In some cases, the coiled spring has a coil diameter of less than about 0.005 inch (e.g., less than about 0.0025 inch).

In some embodiments, the socket comprises a contact spring disposed within the socket cavity. In some cases, the pin body comprises an enlarged end and the pin is received into the socket such that the contact spring engages sides of the pin body between the pin head and the enlarged end. In some cases, the contact spring comprises a first spring end and a second spring end, the first spring end having a greater diameter than the second spring end, the first spring end disposed nearer the pin head than the second spring end.

In some embodiments, the socket retaining element includes projections extending outward from an outer surface of the socket body.

In some embodiments, the socket retaining element includes projections extending inward from an inner surface of the socket body.

In some embodiments, the socket retaining element includes a contact spring disposed within the socket cavity, the contact spring having a first spring end and a second spring end, the first spring end having a greater diameter than the second spring end, the first spring end disposed nearer the pin head than the second spring end. In some cases, the pin body includes an enlarged end and the pin is received into the socket such that the contact spring engages sides of the pin body between the pin head and the enlarged end.

In some embodiments, the socket head comprises an open end of the socket body. In some cases, the socket head further includes a contacting element inserted into the open end of the socket body with a press-fit engagement between contacting element and the socket body.

In some embodiments, the resilient member provides a conductive path between the pin and the socket.

In some embodiments, the resilient member includes a coiled spring.

In some embodiments, the pin body includes a protrusion extending radially outward from a cylindrical portion of the pin body.

Terminals and intercoupling components (e.g., socket converter assemblies) as described herein can advantageously provide for an increased density of terminal connections. For example, a terminal having a socket which receives a portion of the pin but in which an interposed spring (i.e., resilient member) is not contained within the socket can have smaller outer dimensions than similar terminals in which the socket must be sufficiently large to contain the spring. Thus, intercoupling components can be configured with a decreased pitch or spacing between the centers of adjacent connections (e.g., 0.8 millimeter or 0.5 millimeter).

Another advantage relates to applications in which a specific pitch is desired. Reduced terminal diameters can increase the distance between the outer surfaces of adjacent terminals for intercoupling components of a given pitch (e.g., 1 millimeter). This increased separation can limit the “crosstalk” that can occur between adjacent signal paths in high-density intercoupling components.

The configuration of the pins and sockets can also provide an increased range of motion to compensate for variations of the in the surface of the integrated circuit package being, for example, tested. In addition, because these terminals and intercoupling components can be soldered or connected directly to underlying printed circuit boards, terminals and intercoupling components as described herein dispense with holed drill in printed circuit boards required to install intercoupling components which require separate hold down devices. This can reduce the likelihood of damage to such printed circuit boards.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is an exploded, somewhat diagrammatic, perspective view of a BGA converter socket assembly, a BGA package, and a hold-down assembly positioned over a printed circuit board.

FIG. 2 is a cross-sectional view of the circuit board, two socket terminals of the socket converter assembly, and the BGA package of FIG. 1.

FIGS. 3 - 9 are cross-sectional views of embodiments of socket terminals.

Like reference symbols in the various drawings indicate like elements.

### DETAILED DESCRIPTION

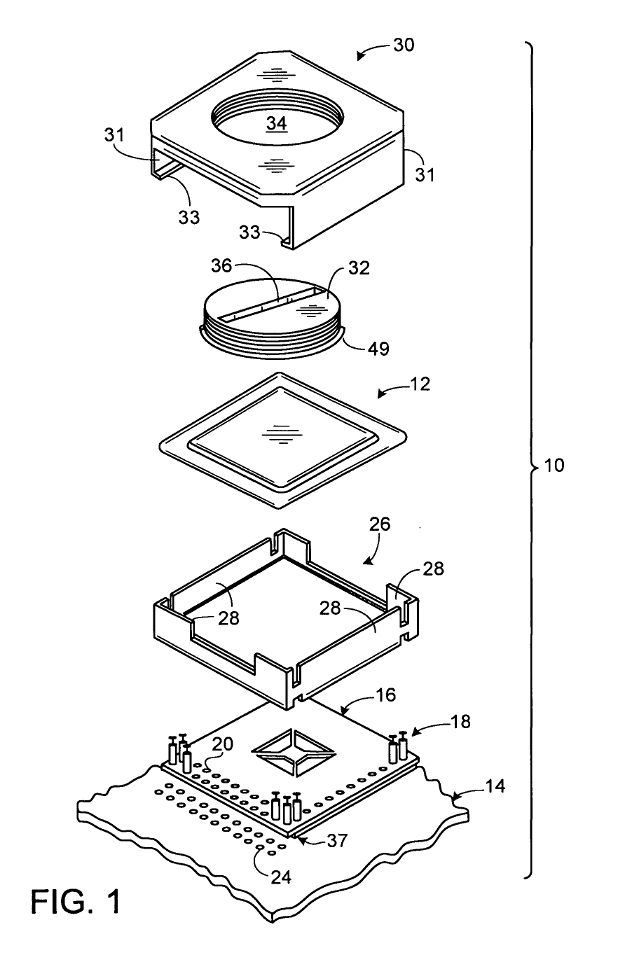

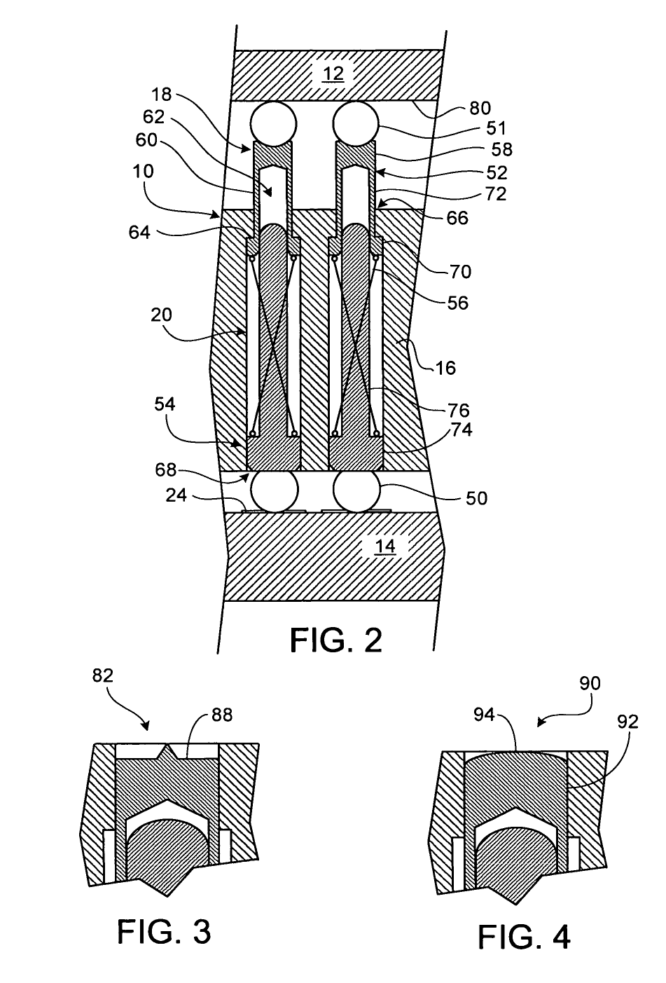

Referring to FIGS. 1 and 2, a socket converter assembly 10 intercouples a BGA package 12 to a printed circuit board 14. Socket converter assembly 10 includes an electrically insulative member 16 (e.g., a unitary sheet of liquid crystal polymer plastic, polyphenyl sulfide (“PPS”), or other electrically insulative material) for supporting converter terminals 18. Each of the terminals 18 is press-fit within a corresponding one of an array of holes 20 (FIG. 2) in insulative member 16. The array of holes 20 is provided in a pattern corresponding to a footprint of rounded solder balls 51 (FIG. 2) of BGA package 12 as well as a footprint of surface mount pads 24 of printed circuit board 14. Insulative member 16 with converter socket terminals 18 is press-fit into a guide box 26 having sidewalls 28 along which the peripheral edges of BGA package 12 are guided so that solder balls 51 of the BGA package (FIG. 2) are aligned over converter socket terminals 18. In some instances, insulative member 16 and guide box 26 can be formed as a one-piece, integral unit. In this illustrative embodiment, socket converter assembly 10 is configured to intercouple BGA package 12 to circuit board 14. However, as described in more detail below, other socket converter assemblies can be configured with similar terminals to intercouple other types of IC packages (e.g., LGA packages or PGA packages) to circuit boards.

As is shown in FIG. 1, socket converter assembly 10 includes a hold-down cover 30 for securing BGA package 12 into the socket converter assembly. Cover 30 includes a pair of opposite walls 31 having tab members 33 which engage recessed portions 37 along the underside of insulative member 16. Hold-down cover 30 includes a threaded thru-hole 34 which threadingly receives a heat sink 32 to provide a thermal path for dissipating heat generated within BGA package 12 from the IC device. Heat sink 32 is inserted and backed-in from the bottom of cover 30 and includes a lip 49 which engages a flat counter-bored surface (not shown) on the bottom surface of the cover to ensure that the heat sink will contact the surface of BGA package 12. A slot 36 formed in heat sink 32 facilitates threading the heat sink (e.g., with a screwdriver or coin) within cover 30. Other latching mechanisms (e.g., clips or catches) may also be used to secure IC packages within the socket converter assembly. In some instances, other heat sink arrangements, including those with increased surface areas (e.g., heat sinks with finned arrangements), are substituted for the lower profile heat sink shown in FIG. 1. In some instances, a heat sink is not required and only cover 30 applies downward force to the IC package.

Referring to FIG. 2, each terminal 18 includes a socket 52, a pin 54, and a resilient member 56. Each socket 52 has a socket head 58 formed at the end of a socket body 60. In this embodiment, socket heads 52 have concave upper surfaces 59 sized to receive and engage solder balls 51 of BGA package 12. A socket cavity 62 is located within socket body 60 of each socket 52 and a socket retainer 70 extends outward relative to an outer surface 72 of the socket body. In the illustrated embodiment, socket body is substantially cylindrical in shape but, in some cases, other shapes and configurations are used. Insulative member 16 has projections or detents 64 defining narrow ends 66 of holes 20 that are oriented toward an IC package (e.g., BGA package 12 as illustrated) when converter assembly 10 is in use. Narrow ends 66 of holes 20 have a smaller cross-sectional dimension (e.g., diameter) than wide ends 68 of the holes. Sockets 52 are configured with socket bodies 60 that are sized to fit though narrow ends 66 of holes 20 with socket retainers 70 sized to fit into wide ends 68 of the holes and engage detents 64. The engagement between socket retainers 70 and detents 64 prevents sockets 52 from passing completely thru-holes 20.

Similarly, pins 54 have pin heads 74 formed at ends of pin bodies 76. Pins 54 are configured with pin bodies 76 sized to have outer dimensions (e.g., diameters) at least slightly smaller than inner dimensions of socket cavities 62 and pin heads 74 sized to engage inner surfaces 78 of wide ends 68 of holes 20. Each pin head 74 is positioned within a corresponding one of the array of holes 20. Pin bodies 76 extend from pin heads 74 and can be received at least partially within corresponding socket cavities 62.

Resilient members 56 are configured to bias socket heads 58 away from pin heads 74. In this embodiment, resilient members 56 are springs (e.g., annular springs such as coiled springs or spring washers) positioned around pin bodies 76 with the resilient member of each terminal 18 extending between pin head 74 and socket retainer 70 of the terminal. In certain embodiments, resilient members 56 are made of electrically conductive material (e.g., beryllium copper, stainless steel, or music wire) such that the resilient members provide a electrically conductive connection between sockets 52 and pins 54. Resilient members 56 are generally sized such, that under normal operation, an outer dimension (e.g., diameter) of the resilient members is smaller than an inner dimension (e.g., diameter) of wide ends 68 of holes 20 and an inner dimension (e.g., diameter) of the resilient members is larger than an outer dimension (e.g., diameter) of pin body 76. Such sizing facilitates the movement (e.g., compression and expansion) of resilient members 56 in response to forces applied to sockets 52 as described below.

The above-described configuration can facilitate the installation of terminals 18 in insulative member 16. In one approach, insulative member 16 is positioned with narrow ends 66 of holes 20 below wide ends 68 of the holes (i.e., rotated 180 degrees from the orientation shown in FIG. 2). Each socket 52 is then placed into corresponding hole 20 with gravity acting to move or help move the socket downward until socket retainer 70 engage detent 64. Each resilient member 56 can then be placed into corresponding hole 20. Each pin 54 can then be placed into a corresponding hole 20 with pin body 76 extending through resilient member 56 (e.g., through the open central region of coiled spring). Pressure can then be applied to pin head 74 and/or solder ball 50 attached to the pinhead to compress resilient member 56 and bring the pin head into a press-fit engagement with insulative member 16. Holes 20 and pins 54 can be sized such that the press-fit engagement between pin heads 74 and insulative member 16 can hold terminals 18 in place against forces applied to the pin heads through sockets 52 and resilient members 56 as BGA package 12 approaches circuit board 14.

In operation, terminals 18 can provide electrically conductive paths between IC package 12 and circuit board 14 with individual terminals providing some degree of compensation for irregularities in the surface and/or electrical contacts (e.g., solder balls 51) of the IC package. For example, if an individual solder ball 51 extends farther from surface 80 of IC package 12 than other solder balls 51, the farther-extending solder ball will contact its corresponding socket head 58 sooner than the other solder balls will contact their corresponding socket heads as the IC package approaches (e.g., is pressed towards) insulative member 16. However, socket head 58 contacted by the farther-extending solder ball 51 will compress resilient member 56 of that specific terminal 18, thus allowing IC package 12 to continue to approach converter assembly 10 such that all solder balls 51 can be brought into engagement with corresponding socket heads. Thus, the movement of individual terminals 18 can provide improved electrical contact between IC package 12 and overall converter assembly 10.

In this embodiment, resilient members 56 provide the primary electrically conductive connection between sockets 52 and pins 54. However, incidental contact between pin 54 and socket 52 can also provide a direct electrically conductive connection between the pin and the socket and, thus, between IC package 12 and circuit board 14. In some instances, the outer surface of pin body 76 and/or the inner surface of socket body 60 can be configured with projections to provide contact between pin 54 and socket 52. However, while such projections can provide a consistent direct electrical contact between pin 54 and socket 52, the resulting contact can also reduce the ease with which the socket moves relative to the pin and, thus, the ability of individual socket terminals 18 to compensate for irregularities in surface 80 and/or solder balls 50 of IC package 12.

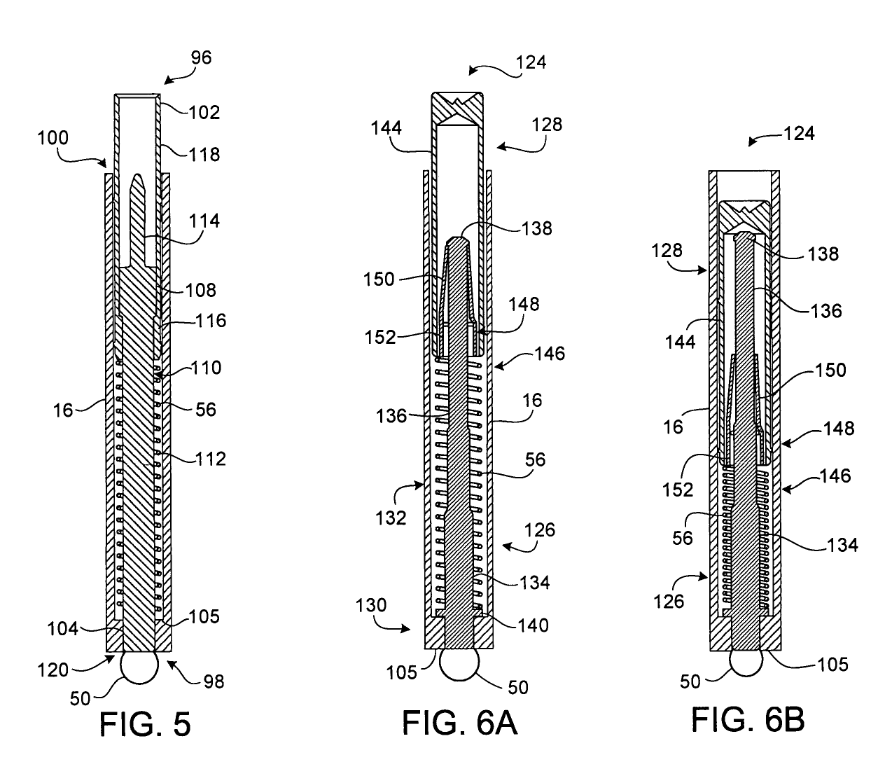

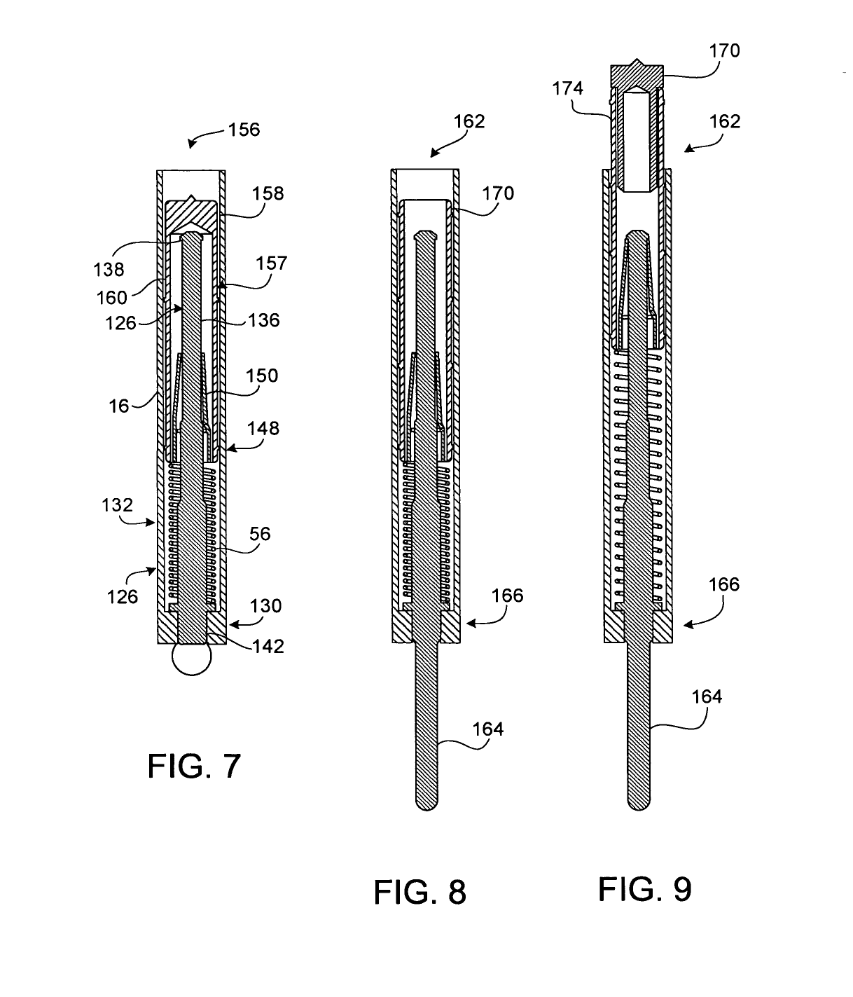

In addition to providing for easy assembly, embodiments of terminals 18 can also provide other advantages including improved electrical characteristics and reduced pitch (i.e., spacing between the centers of adjacent terminals). In general, changes in the diameter of components forming the electrically conductive path through a terminal can produce undesirable effects (e.g., reduced bandwidth, increased insertion and/or return signal losses). By limiting the number of such diameter changes, terminals 18 can have improved electrical characteristics relative to other terminals with more diameter changes. This simpler configuration also can allow for machining of terminals components with small diameters and, thus, manufacture of converter assemblies with pitches of less than about 1 millimeter (e.g., 0.8 millimeter, 0.5 millimeter, or 0.3 millimeter). For clarity of illustration, additional embodiments are illustrated in FIGS. 3-9 with only the insulative member and socket terminals shown. Where the resilient member is shown in a compressed state, it will be understood that such compression would be produced by an IC package engaging the socket heads of the terminals.

Referring to FIGS. 3 and 4, in some embodiments (e.g., in converter assemblies configured to intercouple other types of IC packages to circuit board 14), socket heads can be configured to engage other contacts than solder balls. For example, terminals 82 and terminals 83 are configured in substantially similar fashion to terminal 18 (FIGS. 1 and 2) described above. Terminals 82 and terminals 83 are disposed in insulative member 16 and include pin 54, resilient member 56, and solder balls 50. The primary difference between terminals 18 (FIGS. 1 and 2), terminals 82 (FIG. 3), and terminals 83 (FIG. 4) is in their socket head configurations. Referring to FIG. 3, terminals 82 have sockets 84 with socket heads 86 whose upper surfaces 88 are substantially flat (rather than concave) with pointed projections extending away from the socket heads. The pointed projection can, to some extent, pierce through the layers of oxidation that sometimes form on the contacts of IC packages. Socket heads 86 provide terminals 82 with a configuration that is appropriate for use with IC packages including, for example, LGA packages. Referring to FIG. 4, terminals 83 have sockets 90 with socket heads 92 whose upper surfaces 94 are slightly concave. Socket heads 92 provide terminals 83 with a configuration that is appropriate for use with IC packages including, for example, LGA packages.

Referring to FIG. 5, in some cases, terminals can be is configured such that engagement between the pin and the socket of individual elements retains the socket in the terminal. For example, terminal 96 is disposed in insulative member 16 and includes a pin 98 press-fit within a hole 100 in the insulative member. In this embodiment, resilient member 56 is a coiled spring which can be made of an electrically conductive material. As in the previously embodiments, resilient member 56 biases socket head 102 of socket 104 away from pin head 106. In this embodiment, resilient member 56 is disposed around pin 98 with ends engaging socket 104 and projections 105 extending from insulative member 16. Pin 98 includes a pin body 110 having a proximal section 112 and distal section 114 with intermediate projections 108 extending radially outward from pin body 110 between the proximal and distal sections. In some embodiments, distal section 114 has a smaller diameter than proximal section 112.

Socket 104 has inward socket retainer 116 disposed at the open end of the socket and extending inward from a substantially tubular socket body 118. Thus, socket retainers 116 define a thru-hole with a smaller diameter than at least an adjacent portion of socket body 188. The inner diameter of inward socket retainer 116 is sized to be at least as large as the outer diameter of proximal section 112 of pin body 110 but smaller than the outer diameter of intermediate projections 108 of pin body 110. The inner diameter of at least a portion of socket body 118 is sized to be at least as large as the outer diameter of intermediate projections 108 of pin body 110.

In this embodiment, inward socket retainer 116 is an integrally constructed unit with a substantially annular configuration. However, inward socket retainer 116 can have other configurations (e.g., multiple tabs spaced at intervals around an inner surface of the socket).

As illustrated, socket head 102 can have the same cross-section as socket body 118. This configuration facilitates manufacture of socket 104 as socket head 102 and socket body 118 can be a single integral unit with a inner diameter sized and shaped such that the open end of the socket end can receive and engage electrical contacts of an IC package (e.g., solder balls on a BGA package).

Terminal 96 can be partially assembled before it is installed in insulative member 16. For example, while holding socket 104 with socket head 102 upwards, pin 98 can be placed into the socket with proximal section 112 of pin body 110 extending downward through inward socket retainers 116 such that intermediate projections 108 of pin body 110 engage inward socket retainers 116. The assembled pin 98 and socket 104 can then be reversed and resilient member 56 can be installed around proximal section 112 of pin body before the combined pin/socket/resilient member unit can be pressed into insulative member 16 to bring pin head 106 into press-fit engagement with the insulative member.

In operation, resilient member 56 biases inward socket retainer 116 towards engagement with intermediate projection 108 of pin body 110. This engagement keeps socket 104 from being pushed out of insulative member 16 by resilient member 56. As in previously described embodiments, movement of an IC package (not shown) towards insulative member 16 brings electrical contacts of the IC package into contact with socket 104 and compresses resilient member 56. In this embodiment, pin 98 and socket 104 are sized to produce ‘wiping’ engagement between intermediate projections 108 of pin body 110 and socket body 118 as well as between inward socket retainers 116 and proximal section 112 of the pin body. This wiping engagement provides for a direct electrical path between socket 104 and pin 98 that can be supplemented by a secondary electrical path through resilient member 56. In some cases, distal section 114 of pin 98 can extend to or slightly past an upper surface 122 of insulative member 16 such that movement of the IC package (not shown) towards the insulative member can bring electrical contacts of the IC package into contact with the distal section of the pin.

In terminals with socket heads including pointed projections (see FIGS. 2 and 3), the pointed projections can leave ‘witness’ marks or indentations on the ends of the solder balls of BGA packages. In some cases, this can be undesirable because some users perceive such indentations as a possible source or harbor for contamination. Referring to FIG. 5, open-ended socket heads 102 can be less likely to leave witness marks and, to the extent that they occur, on the sides rather than bottoms of the solder balls.

Referring to FIGS. 6A-9, in some cases, sockets can include a contact spring, rather than the socket retainers described above. Such contact springs can provide electrical contact between pins and sockets and can also act as a mechanism to keep the sockets in place on the pins. Similarly, in some cases, pins can include a retention feature to aid or replace the press-fit engagement between the insulative member and the pins.

For example, referring to FIGS. 6A and 6B, terminal 124 is configured with a double-headed pin 126, a contact spring socket 128, and resilient member 56 interposed between the pin and the socket in a substantially similar fashion to terminal 96 illustrated in FIG. 5 and described above. Double-headed pin 126 includes first pin head 130 with an attached solder ball 50, a pin body 132 with a proximal section 134 adjacent the first pin head and a distal section 136, and a enlarged end 138 disposed at an opposite end of the pin body from the first pin head. First pin head 130 includes outwardly extending shoulders 140 and main head section 142. In this embodiment, proximal section 134 has a larger outer diameter than distal section 136. The larger size of proximal section 134 provides increased strength and stability to pin 126. In some embodiments, pin body 132 can have other configurations (e.g., multiple sections, a gradually varying outer diameter, or a single constant outer diameter). Double-headed pin 126 is disposed in insulative member 16 with main head section 142 in press-fit engagement with projections 105 from insulative member 16 and with shoulders 140 engaging a top surface of the projections from the insulative member. Resilient member 56 is disposed with one end engaging shoulders 140 of first pin head 130 and the other end engaging contact spring socket 128.

Contact spring socket 128 has a hollow socket body 144 with an open end 146 in which a contact spring 148 is disposed. In this embodiment, contact spring 148 has multiple leaves 150 extending from an annular base 152. Annular base 152 is disposed at or near open end 146 of socket body 144 with spring leaves 150 extending into the socket body from the base. Spring leaves 150 are biased towards a rest position in which the leaves extend diagonally inwards relative to an inner surface of annular base 152. Spring leaves 150 are sized and configured such that, in the rest position, the distance between the ends of the leaves that are farthest from base 152 is less than the outer diameter of distal section 136 of pin body 132.

Contact spring socket 128 has a socket head 154 with a concave upper surface from which a pointed projection extends. Socket head 154 configures terminal 124 to receive and engage solders balls of a BGA package (not shown). However, use of different socket head configurations allows the use of contact spring sockets with other types of IC packages (e.g., LGA or PGA packages). For example, referring to FIG. 7, terminal 156 has contact spring socket 157 with a socket head 158 with a substantially flat upper surface from which a pointed projection extends thus configuring the socket head 158 to receive and engage electrical contacts of an LGA package (not shown). Other elements of terminal 156 are substantially similar to those illustrated in FIGS. 6A and 6B and described above.

Referring to FIGS. 6A-7, when terminal 124 and terminal 156 are assembled, distal section 136 and enlarged end 138 of pin 126 are inserted through contact spring 148 into socket body 144, 160. The configuration of contact spring 148 biases spring leaves 150 towards engagement with an outer surface of pin body 132. At the same time, resilient member 56 biases contact spring socket 128, 158 away from first pin head 130. Engagement between enlarged end 138 of pin 126 and spring leaves 150 keeps contact spring socket 128, 157 from being pushed out of insulative member 16 by resilient member 56 (see FIG. 6A).

Referring to FIGS. 6A-7, this configuration facilitates installation of terminals 124, 156 in insulative member 16. Pins 126 can be inserted into insulative member 16 until main head sections 142 are press-fit into the insulative member and shoulders 140 engage a top surface of the projections from the insulative member. Resilient members 56 can then be disposed into insulative member 16 around pins 126. As contact spring sockets 128, 157 are then pressed onto pins 126, enlarged ends 138 of the pins pass through contact spring leaves 150. After enlarged ends 138 are past contact spring leaves 150, the bias of the contact spring leaves towards their rest position can maintain ends of the contact springs leaves in contact with pin bodies 132.

In operation, these terminals 124, 156 function in substantially the same fashion as those embodiments previously described. However, shoulders 140 extending from first pin heads 130 provide an additional mechanism resisting forces applied to pins 126 through contact spring sockets 128, 157 and resilient members 56 as an IC package (not shown) approaches circuit board (not shown). This additional mechanism allows for greater tolerances in sizing the holes and pins 126 as the press-fit engagement between first pin heads 130 and insulative member 16 are not alone in keeping these forces from forcing the pins out of the insulative member. Shoulders 140 can also function to keep pins 126 in place as solder balls 50 are reflowed to attach a converter socket assembly to a circuit board.

In some embodiments, first pin heads 130 and/or insulative member 16 can be deliberately sized to provide for a reduced press-fit engagement between the first pin heads and the insulative member such that it is feasible to replace damaged pins by pulling them out of insulative member 16. Similarly, contact spring leaves 150 can be configured such that the bias of the spring leaves towards their rest position which provides an engagement with enlarged end 138 of pins 126 which counters the forces applied by the resilient members 56 but allows application of additional force (e.g., by pulling) to remove contact spring sockets 128, 157 for replacement. Such replacement can be desirable to replace damaged sockets and/or to reconfigure terminals 124, 156 for other electrical contacts.

A number of embodiments of the invention have been described. Nevertheless, it will be understood that various modifications may be made without departing from the spirit and scope of the invention. For example, referring to FIGS. 8 and 9, some terminals can have solder tails 164 (rather than solder balls) that extend from double-headed pins 166 that are otherwise substantially similar to pins 126 (see FIGS. 6A-7). In some cases, solder tails 164 can be inserted into prepared sockets in a circuit board to provide electrical connections without a need for actual soldering to provide for attachment to the circuit board. In some cases, solder tails 164 can be inserted through thru-holes extending through a circuit board and then reflowed to provide attachment and electrical connection to the circuit board. In another example, contact spring sockets 168 can be configured with open ends 170 for receiving solder balls of BGA packages as described above (see FIG. 5). Referring to FIG. 9, such open-ended sockets 168 can be converted for contact with other IC packages by addition of inserted socket heads 172 which is sized such that outer surfaces 174 of the inserted heads can be press-fit into open ends 170 of the sockets. Accordingly, other embodiments are within the scope of the following claims.

What is claimed is:

1. An intercoupling component used to couple an array of electrical connection regions disposed on a first substrate to an array of electrical connection regions disposed on a second substrate, the intercoupling component comprising:
an insulative support member including an array of holes extending therethrough, the array of holes located in a pattern corresponding to the array of electrical connection regions on the first substrate; and
a plurality of terminals, each terminal including:
a socket including a socket body extending from a socket head, the socket defining a socket cavity within the socket body;
a pin including a pin body extending from a pin head, the pin head positioned within one of the array of holes and contacting the insulative member, the pin body at least partially received within the socket cavity; and
a resilient member configured to bias the socket head away from the pin head.

2. The intercoupling component of claim 1, wherein the resilient member comprises electrically conductive material and forms part of a first electrically conductive path between the array of electrical connection regions disposed on the first substrate to the array of electrical connection regions disposed on the second substrate.

3. The intercoupling component of claim 2, wherein contact between the pin and the socket forms part of a second electrically conductive path between the array of electrical connection regions disposed on the first substrate to the array of electrical connection regions disposed on the second substrate.

4. The intercoupling component of claim 3, wherein the pin body comprises a protrusion extending radially outward from a cylindrical portion of the pin body.

5. The intercoupling component of claim 4, wherein the socket body comprises a protrusion extending into the socket cavity.

6. The intercoupling component of claim 1, wherein each hole includes a first section having a first diameter and a second section having a second diameter that is smaller than the first diameter.

7. The intercoupling component of claim 6, wherein the pin head is press-fit within the first section of a corresponding hole.

8. The intercoupling component of claim 6, wherein the pin head is press-fit within the second section of the corresponding hole.

9. The intercoupling component of claim 1, wherein the pin head comprises a proximal contacting surface.

10. The intercoupling component of claim 9, wherein the proximal contacting surface comprises a ball-shaped end.

11. The intercoupling component of claim 1, wherein the socket head comprises a concave ball-contacting surface.

12. The intercoupling component of claim 1, wherein the socket head comprises a sharp protrusion extending from a contacting surface.

13. The intercoupling component of claim 1, wherein a lateral distance between centers of adjacent holes is less than about 0.8 millimeter.

14. The intercoupling component of claim 1, wherein the resilient member comprises a coiled spring.

15. The intercoupling component of claim 14, wherein the coiled spring has a coil diameter of less than about 0.005 inch.

16. The intercoupling component of claim 15, wherein the coiled spring has a coil diameter of less than about 0.0025 inch.

17. The intercoupling component of claim 1, wherein the socket comprises a contact spring disposed within the socket cavity.

18. The intercoupling component of claim 17, wherein the pin body comprises an enlarged end and the pin is received into the socket such that the contact spring engages sides of the pin body between the pin head and the enlarged end.

19. The intercoupling component of claim 17, wherein the contact spring comprises a first spring end and a second spring end, the first spring end having a greater diameter than the second spring end, the first spring end disposed nearer the pin head than the second spring end.

20. A terminal for use with an integrated circuit package having an array of electrical connection regions disposed on a first substrate, the terminal comprising:
a socket including a socket body extending from a socket head, a socket cavity formed within the socket, and a socket retaining element disposed on an opposite end of the socket body from the socket head;
a pin including a pin body extending from a pin head, the pin body at least partially received within the socket cavity; and
a resilient member configured to bias the socket away from the pin head.

21. The terminal of claim 20, wherein the socket retaining element comprises projections extending outward from an outer surface of the socket body.

22. The terminal of claim 20, wherein the socket retaining element comprises projections extending inward from an inner surface of the socket body.

23. The terminal of claim 20, wherein the socket retaining element comprises a contact spring disposed within the socket cavity, the contact spring having a first spring end and a second spring end, the first spring end having a greater diameter than the second spring end, the first spring end disposed nearer the pin head than the second spring end.

24. The terminal of claim 23, wherein the pin body comprises an enlarged end and the pin is received into the socket such that the contact spring engages sides of the pin body between the pin head and the enlarged end.

25. The terminal of claim 20, wherein the socket head comprises an open end of the socket body.

26. The terminal of claim 25, wherein the socket head further comprises a contacting element inserted into the open end of the socket body with a press-fit engagement between contacting element and the socket body.

27. The terminal of claim 20, wherein the resilient member provides a conductive path between the pin and the socket.

28. The terminal of claim 20, wherein the resilient member comprises a coiled spring.

29. The terminal of claim 20, wherein the pin body comprises a protrusion extending radially outward from a cylindrical portion of the pin body.

30. A method of assembling an intercoupling component used to couple an array of electrical connection regions disposed on a first substrate to an array of electrical connection regions disposed on a second substrate, the method comprising:
providing an insulative support member including an array of holes extending therethrough, the array of holes located in a pattern corresponding to the array of electrical connection regions on the first substrate;
inserting a socket into each of the array of holes;
inserting a pin having a pin body extending from a pin head into each of the array of holes such that the pin head contacts the insulative support member; and
inserting a resilient member into each of the array of holes;
such that, after the socket, the pin, and the resilient member are inserted, the resilient member is interposed between the pin head and the socket and the pin body is received within a socket cavity defined within the socket.
